(19) United States
(12) Patent Application Publication
(10) Pub. No.: US 2025/0326104 A1
(43) Pub. Date: Oct. 23, 2025

(54) METHOD FOR ASSEMBLING A STRUCTURE FOR A TOOL HOLDER AND AN APPARATUS COMPRISING SAID TOOL HOLDER, AND CORRESPONDING STRUCTURE AND APPARATUS

(71) Applicant: AXL TECHNOLOGIES, FERNEY-VOLTAIRE (FR)

(72) Inventor: Olivier EUGENE, FERNEY-VOLTAIRE (FR)

(73) Assignee: AXL TECHNOLOGIES, FERNEY-VOLTAIRE (FR)

(21) Appl. No.: 18/707,961

(22) PCT Filed: Nov. 7, 2022
(86) PCT No.: PCT/EP2022/080982

§ 371 Date: Sep. 18, 2024

(30) Foreign Application Priority Data
Nov. 9, 2021 (FR) FR2111889

(51) Int. Cl. B25H 1/00

(52) U.S. Cl. CPC B25H 1/0042

(57) ABSTRACT

A method for transporting and assembling a tool holder structure, including: selecting sets of structural elements; each set having a weight designed to enable a single person to lift and transport a set; transporting the set(s) of structural elements; forming a structural part by joining profiled elements together and to end pieces originating from the set(s) which were selected and transported in steps A and B; on the structural part formed, securing the ends of a toothed belt to ends of the structural part, and mounting a trolley on said structural part by causing the toothed belt to engage with the trolley, the toothed belt and the trolley originating from the set(s) which were selected and transported in steps A and B; securing the structural part at the legs thereof by anchoring.

The technical field relates to that of structures that can receive and move a tool holder for actuating a tool opposite or against a surface or a wall.

The technical field also relates to that of allowing receiving and moving a tool apparatuses opposite a surface or a wall, so that said tool acts on said surface or wall.

The technical field also relates to that of methods for mounting and dismounting said structures, and to methods for mounting, dismounting and using said apparatuses.

The is interesting quite invention particularly in the context of the field of public works.

In fact, the invention quite particularly allows providing assistance to a contractor or artisan working alone on a site where all or part of a building is under construction or refurbishing, and using a means of locomotion in the form of a light vehicle.

This contractor or artisan uses, in a known manner, equipment on his/her construction sites, said equipment being lightweight (so that he/she could move it simply from one place to another and handle it) and compact. This enables him/her to be able to bring his/her equipment to an area where work is to be done, even if the latter is difficult to access, like for example a room at a high floor, by passing through a scaffold, the stairs being inaccessible.

The used equipment includes in particular electro-portable or electropneumatic tooling.

With this tooling, this artisan alone carries out repetitive yet accurate operations, like, for example, application of coating, sanding, drilling holes at defined distances, pickling, paint operations, demolition, or creation of an opening in a surface.

The operations may be carried out on a wall, a floor, a ceiling, or an inclined surface, in a room or a defined place.

These operations are tiring, accurate and repetitive. They are dangerous and tedious.

The contractor or artisan alone cannot carry out two operations at two different locations simply, or use two tools successively or alternately.

While, in the past, the artisans have been supported by apprentices, it has become currently difficult to find a qualified and inexpensive workforce.

Hence, an objective of the invention is to provide a solution allowing assisting a contractor or an artisan alone, for carrying out repetitive yet accurate tasks.

Another objective of the invention is to provide a compact assistance solution that is easily transportable, easy to implement, mount, dismount and use, and allowing relieving a contractor or an artisan alone from tedious and dangerous operations, by proposing a robust and secure solution.

For this purpose, the invention relates to a method for mounting a tool holder structure, capable of receiving and moving a tool holder for actuation of a tool opposite or against a surface or a wall.

This method includes the following steps:
A) selecting one or more set(s) of main structural elements, and optionally one or more complementary set(s) of structural elements, according to the dimensions of the wall or of the surface opposite or against which said structure is intended to be mounted;
B) optionally transporting the set(s) of main structural elements, and optionally the complementary set(s), proximate to said surface or wall;
C) forming a structural portion by assembling profiled elements together and with endpieces, by cooperating a male end of a profiled element with a female end of another profiled element or of an endpiece, or vice versa, and securing the whole by securing means of said structural portion;
D) if a motor-driven trolley is intended to be mounted on the formed structural portion, securing ends of a toothed belt on ends of the structural portion, proximate to or on the endpieces of said structural portion, and mounting a trolley on said structural portion by cooperating the belt with the trolley;
E) optionally forming other structural portions if an actuation of a tool is provided for, not only along or against a portion of one single surface or wall, but over or against a surface or wall or over or against several surfaces or walls, and assembling the structural portions together or one or more structural portion(s) with one or more trolley(s);
F) securing the structural portion(s) at their legs by anchoring means, reversible or not, to said surface or wall, and/or to surfaces or walls adjacent to said surface or wall;
G) optionally, adding to the structure, thus mounted, complementary structuring means.

Thus, a structure adapted to the surface or to the wall against or opposite which a tool is intended to be actuated is obtained. The profiled elements of the sets of main structural elements and optionally complementary sets have different lengths, which allows adapting the length of the structural portions to the dimensions of the surface or wall opposite which the structure is mounted.

This method allows proposing a quick and simple method for mounting in any place a robust, economical, secure, lightweight and transportable structure by one person alone to treat a given surface or wall, able to carry out an accurate, repetitive and dangerous specific task.

The sets of structural elements can be moved by one person alone, which facilitates transport thereof from the storage location to where the surface or the wall opposite which the structure should be mounted.

Mounting is simple and rapid and the structure obtained thanks to the means for securing the structural portions, anchoring means, and optionally complementary structuring means (like movable counter-force legs as described later on) is robust enough to withstand loads such as vibrations, forces exerted by a tool against the opposite surface having at least the maximum value that a human being can exert.

Besides being robust, lightweight and transportable, this structure includes belts that enable an accurate motor-driven movement of one or more trolley(s).

By inclination means described later on, such a structure can place structural portions opposite inclined walls or surfaces, and even opposite a ceiling.

Such a structure is lightweight, modular, easy to mount and dismount according to a method reverse to the previously-described mounting method, the elements that make it up can be moved and handled simply by one person alone. Once dismounted, the sets are compact and easily transportable by one person alone.

The invention also relates to a method for mounting and implementing an apparatus including such a structure mounted according to the previously-described method, this apparatus allowing receiving and moving a tool opposite a surface or a wall, so that said tool acts on said surface or wall.

This method includes the following steps:
1/ mounting by one person alone a structure according to the previously-described method, to place it opposite a surface or a wall,
2/ installing one or more tool holder(s) able to receive a tool on one or more trolley(s) mounted on one or more structural portion(s),
3/ mounting one or more tool(s) on one or more tool holder(s),
4/ connecting the trolley(s) and optionally of the tool holder(s) to power supply sources and to control means,
5/ programming and/or controlling by the control means actions to be carried out on said surface or wall by the tool and/or the tool holder and/or the trolley(s).

This mounting method allows proposing a solution for assisting one person alone to treat a surface with tooling by carrying out an accurate, repetitive and dangerous specific task in a difficult access environment.

This method allows obtaining a robust apparatus, in particular the structure that it comprises, and which has an easy assembly of the whole, in particular the structure, without any risk of assembly error, and economical, capable of receiving a tool on a tool holder.

This method also enables the apparatus, and in particular the structure, to withstand loads such as vibrations, forces exerted by the tool against the surface having at least the maximum value that a human being can exert.

The invention further to relates an apparatus configured for the implementation of the previously-described method, this apparatus can be transported in sets and mounted by one person alone, and is able to enable one or more tool(s) to be actuated in a repetitive and accurate manner on or against a wall or a surface, irrespective of its dimensions or its inclination.

This results in ease of work for the contractor or the artisan and greater efficiency.

This apparatus can be controlled by control means such as a computer or a human-machine interface, on site or remotely by means of transmission means, connected to the trolley(s) and/or tool holders and/or to the power supply sources, and/or optionally to the tool(s).

This apparatus can receive several tools, acting simultaneously or successively, and can enable a change of a tool on the tool holder, or of a portion of said tool.

Thus, the actuation of the tool(s) carried by this apparatus can be automated or programmed to carry out repetitive and accurate tasks.

In fact, this apparatus enables a contractor or an artisan to carry out repetitive and accurate tasks, even remotely or in his/her absence, while being mobile and transportable and adaptable, and that being so at a low cost.

Other aims and advantages of the present invention will become apparent throughout the following description referring to the appended drawings illustrating embodiments and wherein:

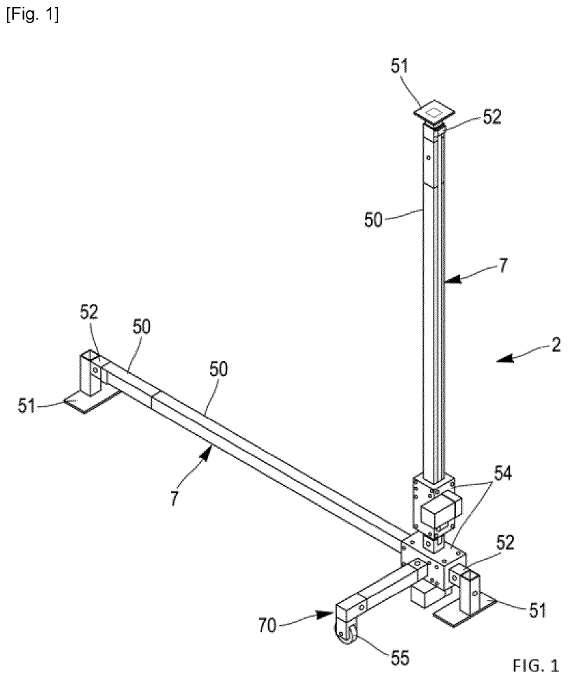

FIG. 1 is a schematic perspective view of a first mounting configuration of a structure according to the invention;

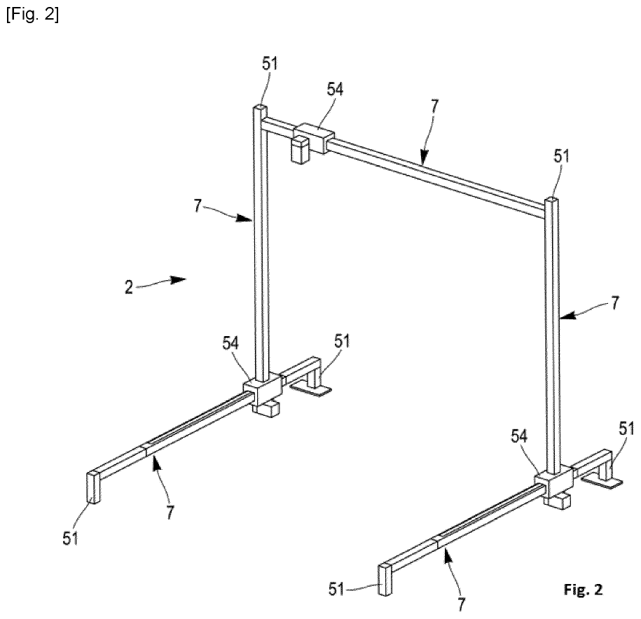

FIG. 2 is a schematic perspective view of a second mounting configuration of a structure according to the invention;

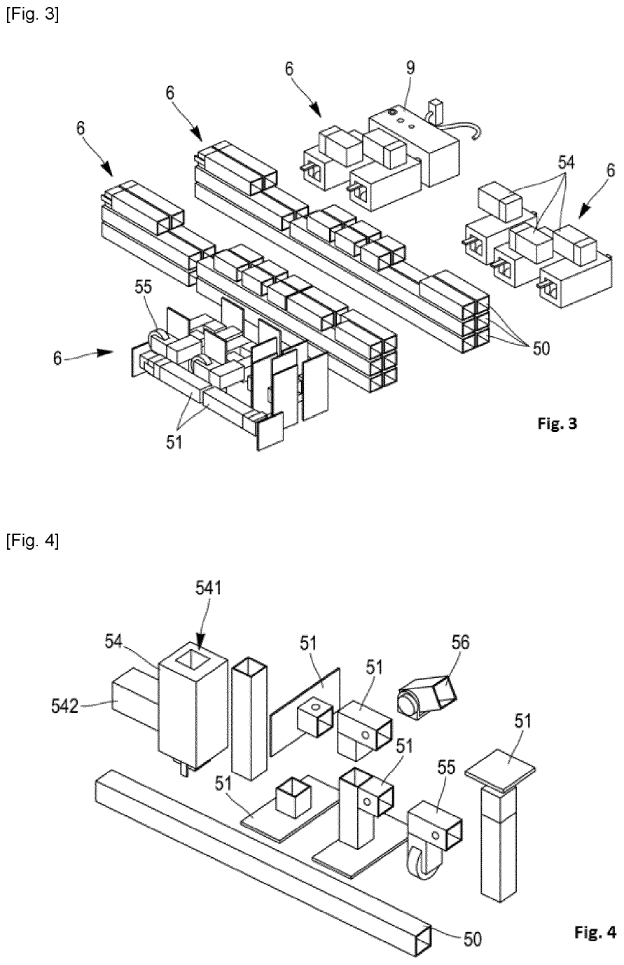

FIG. 3 is a schematic perspective view of different sets of structural elements according to the invention, each set could be packaged and transported by one person alone;

FIG. 4 is a schematic perspective view of a set of structural portions including in particular a trolley, different types of legs, a profiled element, portions of complementary structuring means;

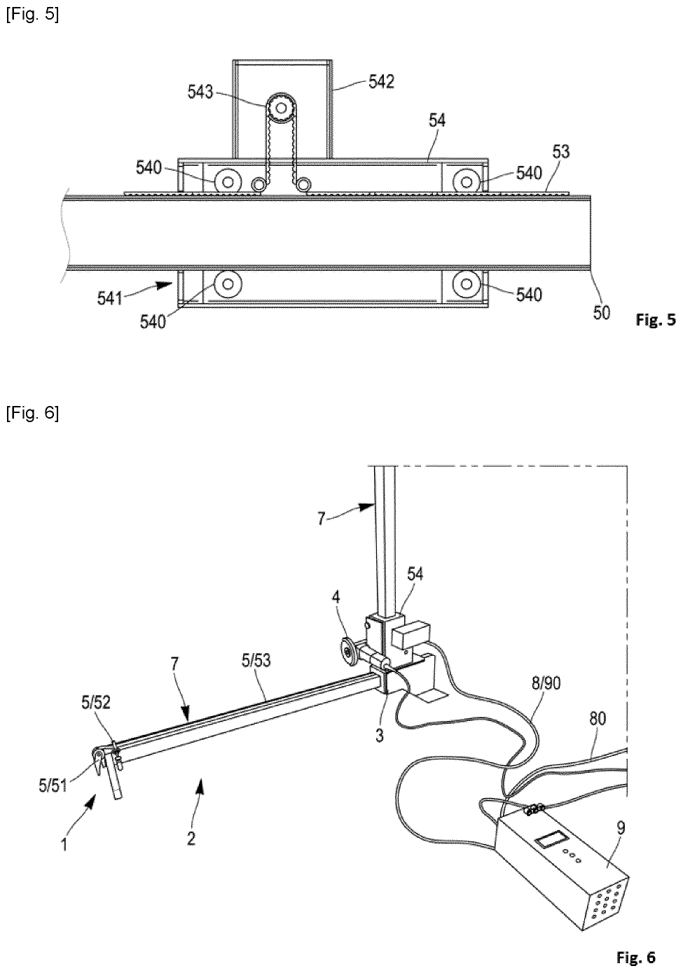

FIG. 5 is a schematic sectional view of a trolley fitted on a structural portion;

FIG. 6 is an image view showing an apparatus on which a tool is mounted on a tool holder, configured for actuation against a vertical surface or wall;

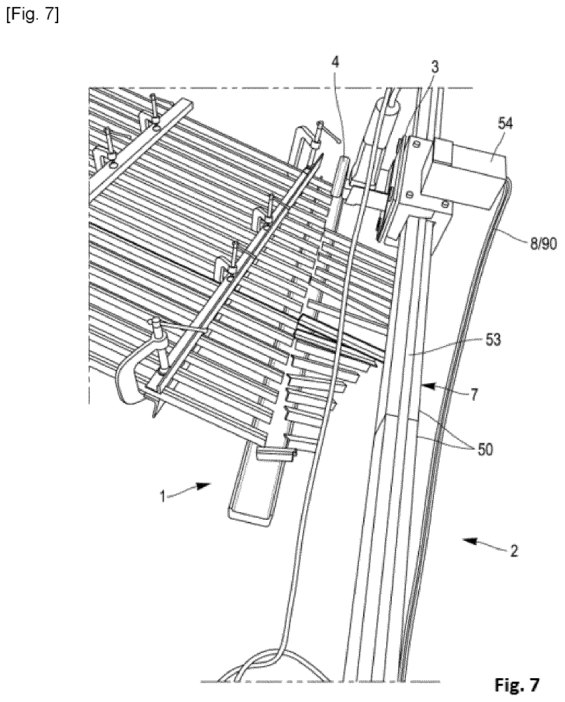

FIG. 7 is an image view showing an apparatus on which a tool is mounted on a tool holder, configured for actuation in the direction of the ground.

The invention relates to an apparatus 1 that includes a structure 2 and at least one tool holder 3 allowing receiving one or more tool(s) 4, in particular electro-portable or electropneumatic tools.

This apparatus 1 is configured to enables actuation of one or more tool(s) 4 repeatedly and accurately on or against a wall or a surface, irrespective of its dimensions or its inclination.

Referring to FIGS. 1, 2, 6 and 7, the apparatus 1 and the structure 2 that it includes are considered to be in their assembled and use position, laid on the ground, having a top portion located at the top of the figures, a bottom portion located at the bottom of the figures.

The structure 2 is formed of structural elements 5 which could form sets 6, as illustrated in FIG. 3, showing five juxtaposed sets. Each set 6 has a weight lower than 30 kilograms, preferably yet optionally lower than 20 kilograms. Each set 6 can be lifted and moved by one person alone. To do so, each set 6 may be stored in a case or any other package, not illustrated in the figures. The structure 2 may include so-called main sets 6, including structural elements 5 for example sufficient to form a structure 2 having dimensions of four metres by three metres, suited to an operation of a tool 4 on or against a wall or floor portion, and so-called complementary sets, including structural elements 5 which complement the main sets in order to increase the dimensions of the structure 2, or to adapt said structure 2 to an operation of a tool 4 on or against an inclined wall or ceiling portion.

The structural elements 5 may be profiled elements 50, legs 51, terminals 52, toothed belts 53, trolleys 54, rolling endpieces 55, inclination interfaces 56. The legs 51, the rolling endpieces 55, the inclination interfaces 56 are endpieces 51, 55, 56.

The structural elements 5 may be assembled to form one or more structural portion(s) 7. A structural portion 7 uses one or more profiled element(s) 50, herein square-shaped, made of aluminium or steel, including a male end and a female end. Several profiled elements 50 may be assembled together to form a longer profiled element by cooperating by interlocking a male end of a profiled element 50 with a female end of another profiled element 50. At the ends of the profiled element 50 or the interlocked profiled elements 50, endpieces 51, 55, 56, i.e. legs 51, rolling endpieces 55, or inclination interfaces 56, are assembled by interlocking. Afterwards, these successive interlockings are locked by securing means, for example by tensioning a metal cable passing through the profiled elements 50, hooked at one or more endpiece(s), i.e. one or more leg(s) 51, one or more rolling endpiece(s) 55, one or more inclination interface(s) 56, on either side of the structural portion 7.

To facilitate the assembly of the profiled elements 50 and to ensure a proper mounting, the section of the profiled elements 50 may include a shape that can cooperate with a counter-form, forming a foolproof device.

Some structural portions 7 may be intended to receive one or more trolley(s) 54.

Terminals 52 may be added to the structural portion 7 to stop the travel of the trolley 54 along the profiled element(s) 50, either by blocking the movement of the trolley 54, or by detection of said terminals 52 if said trolley 54 includes suitable sensors. Thus, the terminals 52 may consist of magnetic tags and the trolley 54 equipped with means for detecting a magnetic field along the profiled element 50. The endpieces, i.e. the legs 51, the rolling endpieces 55, the inclination interfaces 56, may also include terminals 52.

If one or more trolley(s) 54 are mounted on a structural portion 7, a toothed belt 53 is then mounted on one face of the profiled element(s) 50 and the longitudinal ends of said belt 53 secured on ends of the structural portion 7 proximate to or on the endpieces, i.e. the legs 51, the rolling endpieces 55, the inclination interfaces 56 of said structural portion 7. The toothed belt 53 is not mounted tensioned, but forms a loop. The toothed belt 53 is arranged with notches facing the face of the profiled element(s) 50 of the structural portion 7.

A trolley 54 is in herein the form of a square tube, able to be fitted onto a profiled element 50, and including rollers 540 for centring the profiled element 50 in a through opening 541 of the trolley 54. The trolley 54 includes a motor unit 542, in particular electric, driving a toothed wheel 543 which can be engaged in the loop of the toothed belt 53, with no backlash, as schematically illustrated in FIG. 5. Alternatively, the toothed belt 53 can be engaged through the trolley 54 to cooperate with the toothed wheel 543, as illustrated in FIG. 5. Thus, when the motor rotates the toothed wheel 543, the trolley 54 moves by cooperating with the profiled element(s) 50 and the toothed belt 53.

Some structural portions 7 may form complementary structuring means 70, in particular in the case where the structure 2 has a free vertical portion. For example, these complementary structuring means 70 are formed by a profiled element connected to a trolley movable in translation, said profiled element ending at one end by a rolling endpiece 55 in contact with the ground, as illustrated in FIG. 1.

Thus, a structural portion 7 can be assembled fixedly yet reversibly with a trolley 54, for example by bolting, making this structural portion 7 movable in translation relative to another structural portion 7 along which the trolley 54 moves.

Hence, a structural portion 7 may be connected to another structural portion 7, either directly or by a trolley 54, as illustrated in FIG. 2, or also by inclination interfaces 56, as illustrated FIG. 4. These inclination interfaces 56 include two ends pivoting relative to one another about a hinge, each end may be secured to one end of a structural portion 7. This allows forming a structure 2 including an inclined portion so that it is parallel and opposite a surface or a wall.

The structure 2 may have one single dimension, as illustrated FIG. 7, or have two dimensions, as illustrated in FIG. 1, 2 or 6.

The structure 2 may also be completed by other sets 6 to form a three-dimensional structure and be able to simultaneously face two surfaces or walls of the same place.

Structural portions 7 forming a planar set can also be assembled, said planar assembly then being able to be hoisted opposite a surface or a wall at height or inclined, in particular a ceiling, by bearing on other structural portions 7.

It should be noted that the main sets include profiled elements 50 of different sizes, configured to be able to adjust the dimensions of the structure 2 to the portion of a surface or of a wall, within a one-centimetre margin. These main sets may form a kit, as described later on.

The legs 51 may include means for adjusting the length for compensating for the variation in dimensions in case of adjustment within a one-centimetre margin to the structure 2, this being necessary to ensure an exact adjustment of the structure 2 to the dimensions of the opposite surface or wall portion. For example, these adjustment means may be a threaded rod extending from the leg 51 and ending in a bearing surface, said rod being engaged in a nut fixedly secured to said leg 51.

The legs 51 of the same structural portion 7 can ensure holding by bearing on two opposite walls adjacent to the wall or the surface on or against which a tool 4 is intended to be actuated. Alternatively, the legs 51 may be complementarily screwed, nailed or fastened by any other fastening means to the ground or against a wall or a surface on or against which a tool 4 is intended to be actuated.

These different holding means form reversible or non-reversible means for anchoring the structure 2 to a wall or a surface on or against which a tool 4 is intended to be actuated, or to surfaces or walls adjacent to said surface or wall.

Mounting of such a structure 2 may be done by implementing the following steps of a mounting method including the steps of:
A) selecting one or more set(s) 6 of main structural elements 5, and optionally one or more set(s) 6 of complementary structural elements 5, according to the dimensions of the wall or of the surface opposite or against which said structure 2 is intended to be mounted;
B) optionally, transporting the set(s) 6 of main structural elements 5, and optionally the complementary set(s) 6, proximate to said surface or wall;
C) forming a structural portion 7 by assembling profiled elements 50 together and with endpieces 51, 55, 56, by cooperating a male end of a profiled element 50 with a female end of another profiled element 50 or of an endpiece 51, 55, 56, or vice versa, and securing the whole by securing means of said structural portion 7;
D) if a motor-driven trolley 54 is intended to be mounted on the formed structural portion 7, securing beforehand ends of a toothed belt 53 on the ends of the structural portion 7, proximate to or on the endpieces 51, 55, 56 of said structural portion 7, and mounting a trolley 54 on said structural portion 7 by cooperating the toothed belt 53 with the trolley 54. To facilitate mounting of said trolley 54, the belt 53 may be detached at one end, inserted into the trolley 54 and then secured to said end;
E) optionally forming other structural portions 7 if an actuation of a tool 4 is provided for, not only along or against a portion of one single surface or wall, but over or against a surface or wall or over or against several surfaces or walls, and assembling the structural portions 7 together or one or more structural portion(s) 7 with one or more trolley(s) 54;
F) securing the structural portion(s) 7 at their legs 51 by anchoring means, reversible or not, to said surface or wall, and/or to surfaces or walls adjacent to said surface or wall;
G) optionally, adding to the structure 2, thus mounted, complementary structuring means 70. Such a structure 2 may be obtained by implementing the previously-described method. Besides the above-described structure 2, the apparatus 1 includes one or more trolley(s) 54 capable of receiving one or more tool holder(s) 3. The use of trolleys 54 identical to those used to mount the structure 2 allows for manufacturing savings. These tool holders 3 are fixedly mounted secured, reversibly or not, to trolleys 54, and are configured to control and hold tools 4, particular in electro-portable or electropneumatic tools 4.

The apparatus 1 also includes means 8 for connecting the trolleys 54 and/or the tool holders 3 and/or the tools 4 to power supply sources 80, such as batteries or an electrical socket. These power supply sources 80 may be, or not, included in the apparatus 1.

In addition, the apparatus 1 includes means 9 for controlling the trolleys 54 and/or the tool holders 3 and/or the tools 4, in the form of a programming unit or a micro-computer, and means 90 for connecting the trolleys 54 and/or the tool holders 3 and/or the tools 4 to the control means 9, for example in the form of a wired network. It is then possible to program or control actions to be carried out by the tools 4, the structure 2, or the tool holders 3. It is also possible to record commands to be executed in the control means 9 for a subsequent execution.

This apparatus 1 may be mounted by the method including the following steps:
1/ mounting, by one person alone, a structure 2 according to the previously-described method, to place it opposite a surface or a wall,
2/ installing one or more tool holder(s) 3 able to receive a tool 4 on one or more trolley(s) 54 mounted on one or more structural portion(s) 7 configured to receive said trolley(s) 54, i.e. including one or more toothed belt(s) 53,
3/ mounting one or more tool(s) 4 on one or more tool holder(s) 3,
4/ connecting the trolley(s) 54 of the apparatus 1, and optionally the tool holder(s) 3, to power supply sources 80 and to control means 9,
5/ programming and/or controlling actions to be carried out on said surface or wall by the tool 4 and/or the tool holder 3 and/or the trolley(s) 54.

Such an apparatus 1 may receive several tools 4 on one or more tool holder(s) 3, acting simultaneously or successively, in order to be able to actuate tools 4 at different locations of the surface and/or at different time points.

The tool holders 3 may enable a modification of the angle of inclination of the tool 4.

Such a structure 2 and such an apparatus 1 enables set-up by one person alone, from a height lower than the height of a man, while requiring no particular lifting means.

this Thanks to light spot supports, structure 2 does not degrade the surface or wall on or against which a tool 4 is intended to be actuated, or the surfaces adjacent to said surface or wall.

The apparatus 1 may also include means for controlling the planarity, the perpendicularity and the parallelism of the structure 2, with detection of the structural portions 7 in presence and their interactions with one another.

These control means may be in the form of sensors present on the structural portions 7, coupled to software for processing the data of the sensors to form a virtual model of the structure 2.

The apparatus 1 may include means for controlling the flatness, the perpendicularity and the parallelism of the structure 2, including a detection of the elements present, their position on the structure.

These control means may be in the form of sensors present on the structural portions 7, coupled to software for processing the data of the sensors to form a virtual model of the surface or of the wall on or against which a tool 4 could be actuated.

The apparatus 1 may also include one or more tarpaulin(s), transparent or not, allowing covering all or part of the structure 2 and avoiding a passage of dust or projections from the apparatus 1 towards the adjacent areas, and vice versa.

The apparatus 1 may also include remote control means in the form of a camera unit fitted, or not, with a lamp, connected by a wired or radio link to display means of a user of the apparatus 1, for example a computer screen, in order to be able to remotely monitor the works.

This apparatus 1 can be transported and mounted by one person alone, and it is configured to enable actuation of one or more tool(s) 4 in a repetitive and accurate manner on or against a wall or a surface, irrespective of its dimensions or its inclination.

This apparatus 1 has a structure 2 particularly adaptable to a wall, a ceiling, a floor, an inclined plane, a channel, or a line on a surface or a wall.

An example of a kit enabling mounting an apparatus 1 according to the invention and including the so-called main sets 6 may thus, for example, include two rolling endpieces 55, ten terminals 52, six inclination interfaces 56, four legs 51, five trolleys 54, three profiled elements respectively 10, 11, 12, 13 and 14 centimetre long, five profiled elements respectively 50 and 100 centimetre long, three profiled elements respectively 20, 25 and 150 centimetre long. The length of the profiled elements 50 is measured without considering the female end. Such a kit also includes a programming and/or control unit forming programmable control means.

1-3. (canceled)

4. A method for transporting and mounting a tool holder structure by one person alone, said tool holder structure being adapted to receive and move a tool holder for actuation of a tool opposite or against a surface or a wall, said method including the following steps:
A) selecting one or more set(s) of main structural elements, and optionally one or more complementary set(s) of structural elements, according to the dimensions of the wall or of the surface opposite or against which said structure is intended to be mounted; each set having a weight configured to enable one person alone to lift and transport a set,
B) transporting the set(s) of main structural elements, and optionally the complementary set(s), proximate to said surface or wall;
C) forming a structural portion by assembling profiled elements together and with endpieces originating from the set(s) selected and transported in steps A and B, by cooperating a male end of a profiled element with a female end of another profiled element or of an endpiece, or vice versa, and securing the whole by securing means of said structural portion;
D) on a formed structural portion, securing ends of a toothed belt on ends of the structural portion, proximate to or on the endpieces of said structural portion, and mounting a trolley on said structural portion by cooperating the toothed belt with the trolley, the toothed belt and the trolley originating from the set(s) selected and transported in steps A and B;
E) optionally forming other structural portions if an actuation of a tool is provided for, not only along or against a portion of one single surface or wall, but over or against a surface or wall or over or against several surfaces or walls, and assembling the structural portions together or one or more structural portion(s) with one or more trolley(s);
F) securing the structural portion(s) at their legs by anchoring means, reversible or not, to said surface or wall, and/or to surfaces or walls adjacent to said surface or wall;
G) optionally, adding to the structure, thus mounted, complementary structuring means originating from the set(s) selected and transported in steps A and B.

5. A method for mounting and implementing an apparatus including a structure mounted by implementing a method according to claim 4, this apparatus allowing receiving and moving a tool opposite a surface or a wall, so that said tool acts on said surface or wall, said method including the following steps:
1/ setting a surface or a wall of said structure mounted according to the method of claim 1 in an opposite manner by one person alone,
2/ installing one or more tool holder(s) adapted to receive a tool on one or more trolley(s) mounted on one or more structural portion(s),
3/ mounting one or more tool(s) on one or more tool holder(s),
4/ connecting the trolley(s), and optionally the tool holder(s), to power supply sources and to control means,
5/ programming and/or controlling actions to be carried out on said surface or wall by the tool and/or the tool holder and/or the trolley(s).

6. An apparatus including:
a tool holder structure composed of profiled elements and endpieces,
a motor-driven trolley mounted on said tool holder structure,
a tool holder installed on said motor-driven trolley,
a tool mounted on said tool holder and mounted on said tool holder structure,
a control means,
characterised in that said apparatus is formed from one or more set(s) of main structural elements, and optionally one or more set(s) of complementary structural elements; each set having a weight configured to enable one person alone to lift and transport a set, and in that said apparatus is obtained by implementation of the mounting and implementation method according to claim 5 by one person alone.
